(19) United States
(12) Patent Application Publication
(10) Pub. No.: US 2006/0069532 A1
(43) Pub. Date: Mar. 30, 2006

(54) Noise reduction circuit and temperature measuring apparatus equipped with the same

(75) Inventors: Youji Takei, Saitama-ken (JP); Masao Tsukizawa, Gunma-ken (JP)

Correspondence Address: WATCHSTONE P + D, 1300 EYE STREET, NW, 400 EAST TOWER, WASHINGTON, DC, 20005, US

(73) Assignee: Sanyo Electric Co., Ltd.

(21) Appl. No.: 11/237,705

(22) Filed: Sep. 29, 2005

(30) Foreign Application Priority Data
Sep. 29, 2004 (JP) JP 2004-285025

(51) Int. Cl. G06F 15/00

(52) U.S. Cl. 702/191

(57) ABSTRACT

In some embodiments, a noise reduction circuit for use in a temperature measuring apparatus includes a replacing processing portion configured to execute replacing processing for replacing data of one of plural pixels among plural pixels with data of another pixel among the plural pixels, the data of the one of plural pixels being discriminated as noise, and an averaging processing portion configured to execute averaging processing for averaging the data of the one of plural pixels to smooth the data of the one of plural pixels. The averaging processing is executed at the averaging processing portion after executing the replacing processing at the replacing processing portion.

This application claims priority under 35 U.S.C. §119 to Japanese Patent Application No. P2004-285025 filed on Sep. 29, 2004, the entire disclosure of which is incorporated herein by reference in its entirety.

### BACKGROUND OF THE INVENTION

1. Field of the Invention

The present invention relates to a noise reduction circuit for use in temperature measuring apparatuses, which can be applied to an apparatus for measuring temperatures of, for example, human beings or objects by detecting heat ray images of, e.g., far infrared rays irradiated from the human beings or objects. It also related to a temperature measuring apparatus equipped with the noise reduction circuit.

2. Description of the Related Art

The following description sets forth the inventor's knowledge of related art and problems therein and should not be construed as an admission of knowledge in the prior art.

As a temperature measuring apparatus, a two-dimensional thermopile array has been used for detecting temperatures of objects to be measured. The two-dimensional thermopile is constituted by a plurality of thermopiles combined lengthwise and crosswise so that the amount of thermal changes in a certain detecting area can be measured. The thermopile is made by combining a plurality of thermocouples to increase the output voltage. For example, conventionally, such a two-dimensional thermopile array has been installed on a ceiling plane of a microwave oven as a temperature measuring apparatus for measuring the temperature of an object to be heated in the microwave oven in a non-contact manner.

Concretely, as disclosed by Japanese Unexamined Laid-open Patent Publication No. 2001-355853, in a microwave oven, a turn table is set as a temperature measuring area of a two-dimensional thermopile array so that the temperature distribution of an object placed on the turn table can be measured by the two-dimensional thermopile array.

The technique using the aforementioned two-dimensional thermopile array can also be applied to a means for detecting existence of a human body. For example, an illuminating lamp having a built-in two-dimensional thermopile array for detecting a human body has been proposed. A thermopile can also be used for detecting occurrence of fire or existence of human bodies based on the thermal change amount. Among other things, in recent years, a thermopile has been greatly expected to be used in fire alarms and/or security devices for detecting, e.g., human bodies (see, e.g., Japanese Unexamined Laid-open Patent Publication No. 2000-223282).

However, the aforementioned background technique had the following drawbacks. That is, in the aforementioned background technique, the temperature distribution of the detecting area will be displayed on a screen of a displaying device using the light receiving units. The output signals to be outputted from the thermopile constituting the light receiving unit are generally very small in value, and therefore they are generally amplified with an amplifier or the like. At this time, the temperature distribution to be displayed on the screen of the displaying device can be easily affected by noises and measurement errors.

The inclusion of noises and/or measurement errors causes distortion of the temperature distribution, which makes it difficult to distinguish the displayed object for example.

The description herein of advantages and disadvantages of various features, embodiments, methods, and apparatus disclosed in other publications is in no way intended to limit the present invention. For example, certain features of the preferred embodiments of the invention may be capable of overcoming certain disadvantages and/or providing certain advantages, such as, e.g., disadvantages and/or advantages discussed herein, while retaining some or all of the features, embodiments, methods, and apparatus disclosed therein.

### SUMMARY OF THE INVENTION

The preferred embodiments of the present invention have been developed in view of the above-mentioned and/or other problems in the related art. The preferred embodiments of the present invention can significantly improve upon existing methods and/or apparatuses.

Among other potential advantages, some embodiments can provide a noise reduction circuit for use in a temperature measuring apparatus, the noise reduction circuit, comprising:

a replacing processing portion configured to execute replacing processing for replacing data of one of plural pixels among plural pixels with data of another pixel among the plural pixels, the data of the one of plural pixels being discriminated as noise; and

an averaging processing portion configured to execute averaging processing for averaging the data of the one of plural pixels to smooth the data of the one of plural pixels,

wherein the averaging processing is executed at the averaging processing portion after executing the replacing processing at the replacing processing portion.

In some examples, in the noise reduction circuit, it is preferable that the replacing processing portion executes the replacing processing by comparing signals generated at the one of plural pixels at different times, and wherein the averaging processing portion executes the averaging processing by averaging signals generated from the one of plural pixels at different times.

In some examples, in the noise reduction circuit, it is preferable that the replacing processing portion executes the replacing processing by comparing signals generated at the one of plural pixels at different times and replacing the data of the one of plural pixels with data of a pixel before or after the data of the one of plural pixels, and wherein the averaging processing portion averages the data of the one of plural pixels by averaging the data of the one of plural pixels and the data of pixels located around the one of plural pixels to smoothen the data of the one of plural pixels.

In some examples, in the noise reduction circuit, it is preferable that the replacing processing portion replaces data of a central pixel discriminated as noise among data of the plural pixels with any one of data of pixels around the central pixel by comparing data of the central pixel with data of the pixels around the central pixel, and wherein the averaging processing portion smoothens the data of the central pixel by averaging the data of the central pixel and data of the pixels around the central pixel.

In some examples, in the noise reduction circuit, it is preferable that the replacing processing portion replaces data of a central pixel discriminated as noise among data of the plural pixels with data of one of pixels around the central pixel by comparing the data of the central pixel with the data of one of pixels around the central pixel, and wherein the averaging processing portion smoothens the data of the central pixel by averaging the signals generated at the central pixel at different times.

In some examples, in the noise reduction circuit, it is preferable that the replacing processing portion compares data of a central image among three images consecutive in time with data of two remaining images and replaces the data of the central image with one of data of the two remaining images depending on a result of the comparison.

In some examples, in the noise reduction circuit, it is preferable that the replacing processing portion compares one pixel data with pixel data adjacent in two-dimension, and replaces the one pixel data with any one of the adjacent pixel data.

In some examples, in the noise reduction circuit, it is preferable that the replacing processing portion obtains an average value of one pixel data and pixel data adjacent to the one pixel data in two-dimension, and replaces the one pixel data with the average pixel data.

In some examples, in the noise reduction circuit, it is preferable that the averaging processing portion obtains an average value of data of a central screen among three screens consecutive in time and data of two remaining screens, and replaces the data of the central screen with the average value.

In some examples, in the noise reduction circuit, it is preferable that the replacing processing portion compares data of a central image of three screens consecutive in time with data of images of two remaining screens, replaces the data of the central image with data of any one of images of the two remaining screens depending on a result of the comparison, compares one pixel data with pixel data adjacent to the one pixel data in two-dimension, and the averaging processing portion performs the averaging processing after replacing the one pixel data with any one of adjacent pixel data.

In some examples, in the noise reduction circuit, it is preferable that the averaging processing portion obtains an average value of data of one pixel and data of pixels adjacent to the one pixel in two-dimension, replacing the data of the one pixel with the average value, obtains an average value of data of a central screen of three screens consecutive in time and data of two remaining data, and replaces the data of the central image with the average value.

In some examples, in the noise reduction circuit, it is preferable that the replacing processing portion compares data of a central image of three screens consecutive in time with data of images of two remaining screens, replaces the data of the central image with data of any one of images of the two remaining screens depending on a result of the comparison, compares one pixel data with pixel data adjacent to the one pixel data in two-dimension, and replaces the one pixel data with any one of pixel data adjacent to the one pixel data in two-dimension, thereafter, the averaging processing portion obtains an average value of data of one pixel and data of pixels adjacent to the one pixel in two-dimension, replacing the data of the one pixel with the average value, obtains an average value of data of a central screen of three screens consecutive in time and data of two remaining data, and replaces the data of the central image with the average value.

Among other potential advantages, some embodiments can provide a temperature measuring apparatus with a temperature correction function, comprising:

a light receiving portion having a plurality of light receiving units for measuring heat quantity of divided temperature detecting area, the light receiving portion measuring a relative temperature difference between each of the light receiving units and its corresponding divided temperature detecting area in a non-contact manner;

a thermal sensor for detecting a temperature of each of the plurality of light receiving units; and

a replacing processing portion configured to calculate a temperature of each divided temperature detecting area by calculating the temperature from the thermal sensor and the relative temperature difference obtained by the light receiving portion to obtain a temperature of each detecting area, and replace a value discriminated as noise by comparing the calculated result; and

a calculating circuit having an averaging processing portion for smoothening changes by averaging the calculated results,

wherein the calculating circuit executes averaging processing by the averaging processing portion after executing the replacing processing by the replacing processing portion.

In some examples, in the temperature measuring apparatus, it is preferable that the temperature measuring apparatus is applied to a heat detector in which measured values of the detecting area obtained in non-contact manner are amplified.

Among other potential advantages, some embodiments can provide a temperature measuring apparatus equipped with the noise reduction circuit.

With this invention, since noise can be removed and measurement errors can be restrained, the measurement accuracy can be improved remarkably. When this is invention is applied to a thermal detector for example, the resolution can be improved, which makes it easy to specify a displayed object, resulting in high-accuracy fire alarms or security apparatuses for detecting human bodies.

The above and/or other aspects, features and/or advantages of various embodiments will be further appreciated in view of the following description in conjunction with the accompanying figures. Various embodiments can include and/or exclude different aspects, features and/or advantages where applicable. In addition, various embodiments can combine one or more aspect or feature of other embodiments where applicable. The descriptions of aspects, features and/or advantages of particular embodiments should not be construed as limiting other embodiments or the claims.

### BRIEF DESCRIPTION OF THE DRAWINGS

The preferred embodiments of the present invention are shown by way of example, and not limitation, in the accompanying figures, in which:

FIG. 1 is an entire schematic block diagram showing a temperature measuring apparatus according to an embodiment of the present invention;

FIG. 2 is a flowchart showing an example of an operation of a 3DDNR filter according to an embodiment of the present invention;

FIG. 3 is an explanatory view showing the operation of an example of a 3DDNR filter according to the embodiment of the present invention;

FIG. 4 is a flowchart showing an example of an operation of a media filter according to an embodiment of the present invention;

FIG. 5 is an explanatory view showing the operation of an example of the media filter according to the embodiment of the present invention;

FIG. 6 is a flowchart showing an example of a method for obtaining a median value according to the embodiment of the present invention;

FIG. 7 is a flowchart showing an example of an operation of a method of moving averages according to the embodiment of the present invention;

FIG. 8 is an explanatory view showing the operation of a method of moving averages according to the embodiment of the present invention;

FIG. 9 is a flowchart showing an example of an operation of a method of averaging an inter-frame according to the embodiment of the present invention;

FIG. 10 is an explanatory view showing the operation of the method of averaging an inter-frame according to the embodiment of the present invention;

FIG. 11 is a flowchart showing an example of an overall operation of an embodiment of the present invention; and

FIG. 12 is another flowchart showing an example of an overall operation of an embodiment of the present invention.

### DETAILED DESCRIPTION OF THE PREFERRED EMBODIMENTS

In the following paragraphs, some preferred embodiments of the invention will be described by way of example and not limitation. It should be understood based on this disclosure that various other modifications can be made by those in the art based on these illustrated embodiments.

A preferable embodiment of the present invention will be explained with reference to the attached drawings. The following explanation will be directed to a noise reduction circuit and a temperature measuring apparatus with the noise reduction circuit using a thermopile-type far infrared ray area sensor. However, it should be understood that the present invention is not limited to the above and can also be applied to various applications required to measure a surface temperature of an object for detecting, e.g., occurrence of fire or existence of an object such as a human body.

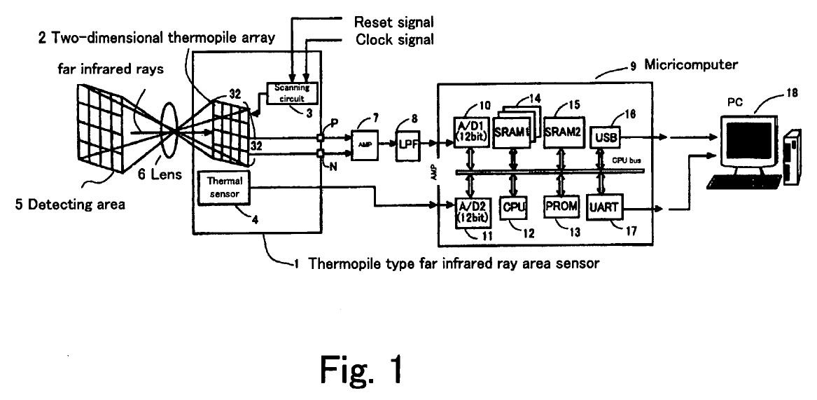

FIG. 1 is a schematic block diagram showing a temperature measuring apparatus according to an embodiment of the present invention. In this apparatus, the thermopile-type far infrared ray area sensor 1 is provided with a two-dimensional thermopile array 2, a scanning circuit 3, and a thermal sensor 4.

In FIG. 1, the reference numeral “5” denotes a detecting area which is a temperature measuring targeted area. The image of the detecting area 5 is introduced into the thermopile-type far infrared ray area sensor 1 through a lens 6 in a reduced manner. The two-dimensional thermopile array 2 mounted in the thermopile-type far infrared ray area sensor 1 generates weak electromotive force corresponding to the amount of far infrared ray irradiated from the detecting area 5 via the lens 6 at each area section of the 32 (height)×32 (width) divided area sections of the entire area of the thermopile array 2.

Based on the weak electromotive force, the two-dimension thermopile array 2 obtains the thermal information of each area section of the detecting area 5.

The thermal information of each area section of the detecting area 5 actually obtained by the two-dimensional thermopile 2 is a temperature difference between each section of the detecting area 5 and the corresponding portion of the two-dimensional thermopile array 2. The two-dimensional thermopile array 2 can only obtain the temperature difference every divided area section of the divided detecting area 5.

The temperature of the two-dimensional thermopile array 2 itself can be measured by the thermal sensor 4.

Accordingly, the temperature of each of the divided area sections of the detecting area 5, which are divided into 32 (height)×32(width) sections, can be obtained by calculating the temperature information from the thermal sensor 4 and the temperature information of each area section of the detecting area 5 obtained by the two-dimension thermopile array 2 using the microcomputer 9.

Clock signals and reset signals are inputted into the scanning circuit 3 mounted in the thermopile-type far infrared ray area sensor 1. The scanning circuit 3 initializes the value of the counter mounted in the scanning circuit 3 every input of reset signal to return the value into zero.

The value of the counter mounted in the scanning circuit 3 is incremented one by one in synchronization with the rising of the inputted clock signal.

The 32×32 divided area sections of the two-dimensional thermopile array 2 have respective addresses with address values increasing from the upper left side thereof toward the lower right side. Utilizing the counter value which will be incremented one by one, the scanning circuit 3 outputs an address value allotted to the two-dimensional thermopile array 2 to each of the divided area sections of the two-dimensional thermopile array 2 in order.

The two-dimensional thermopile array 2 to which the addresses are allotted outputs the information on the temperature difference obtained every corresponding area section as a potential difference (voltage) in order.

The potential difference will be outputted via the P terminal and the N terminal, which are output terminals of the thermopile-type far infrared ray area sensor 1. The P terminal is a P channel terminal with a positive polar, and the N terminal is an N channel terminal with a negative polar.

The potential difference outputted from the thermopile-type far infrared ray area sensor 1 via the P terminal and the N terminal will be inputted to the amplifier 7. The amplifier 7 includes a difference amplifier circuit, and amplifies the potential difference depending on the potential difference between the P terminal and the N terminal to output the amplified potential difference as an output signal.

The amplifier 7 is required to amplify the potential difference at a high magnification rate since the electromotive force to be generated by the two-dimensional thermopile array 2 is weak.

In this embodiment, the amplifier 7 amplifies the potential difference between the P terminal and the N terminal by approximately several thousand times to output to the lowpass filter (hereinafter referred to as “LPF”) 8. The LPF 8 is a lowpass filter constituted by resistors and capacitors, and smoothens the quickly increased noise components among signals contained in the potential difference amplified by the amplifier 7 and then outputs the smoothened signal to the 12 bit A/D converter 10 in the microcomputer 9. The 12-bit AD converter 10 converts the analog signal inputted from the LPF 8 into 12-bit digital data.

The thermal sensor 4 mounted in the thermopile-type far infrared ray area sensor 1 is configured to output the temperature information of each area section of the two-dimensional thermopile array 2 as a potential difference.

The temperature information of the two-dimensional thermopile array 2 is inputted to the 12-bit A/D converter 11 to be converted into 12-bit digital data.

The CPU 12 in the microcomputer 9 obtains the temperature information of each of the area sections, which are the 32×32 divided area sections of the two-dimensional thermopile array 2, based on the temperature information of the two-dimensional thermopile array 2 itself and the voltage output showing the aforementioned temperature difference of each of the area sections of the two-dimensional thermopile array 2.

The aforementioned temperature information obtained by the CPU 12 is a relative temperature showing the difference between the temperature of each area section of the detecting area 5 and the temperature of each area section of the two-dimensional thermopile array 2. In other words, the obtained temperature information shows how higher or lower the temperature of each area section of the detecting area 5 is in comparison with the temperature of the two-dimensional thermopile array 2.

In order to obtain the temperature information of each area section of the detecting area 5, the CPU 12 adds the temperature information of the two-dimensional thermopile array 2 itself to the relative temperature difference between the temperature of each area section of the detecting area 5 and the temperature of each area section of the two-dimensional thermopile array 2.

The CPU 12 makes the SRAM1 14 store the obtained temperature information of each area section of the detecting area 5 via the CPU bus. The temperature information of the 32×32 area sections to be measured once, which is called one frame, will be processed all together as a single information unit.

In this embodiment, the temperature measuring of the detecting area 5 is executed three times per second, and the SRAM1 14 stores the most recent three measured results. The SRAM1 14 erases the oldest measured result and stores the new measured result to keep updating measured results every new measurement. The series of processing is executed by the program stored in the PROM 13. The PROM 13 is constituted by a nonvolatile memory called “flash memory,” so that the program can be rewritten conveniently, e.g., in cases where the program is required to be amended.

In FIG. 1, the SRAM1 14 and SRAM2 15 are illustrated separately. In a memory to be used for a CPU, a memory is generally administered in such a manner that the entire memory is divided into a plurality of sections. Upon request of an access to the memory from the CPU, one of the sections is selected among the entire sections of the memory for reading or writing. The section of the memory is called “bank.”

In place of the aforementioned SRAM1 14 and SRAM2 15, a single SRAM in which the entire memory is divided into two banks, i.e., SRAM1 and SRAM2, can be used. In this case, since a part of the built-in memory address decoder can be shared, the chip area of the microcomputer 9 can be decreased.

Now, the temperature information of each area section of the detecting area 5 can be obtained by the device shown in FIG. 1 every area section of the two-dimensional thermopile array 2 divided by 32 (vertical)×32 (horizontal).

However, in this case, the temperature is measured by a non-contact method utilizing the Seebeck effect in which heat is directly converted into electricity, which is easily affected by noises and/or measurement errors. The noises and/or measurement errors arise from very weak output signals outputted from the thermopile itself and amplification of the signals by, e.g., about several thousand times with the amplifier 7. If the measured temperature is affected by noises, the effects will be shown on the screen of the personal computer 18 showing the temperature distribution of the detecting area 5 as points showing extremely high temperature and points showing extremely low temperature, resulting in wrong recognition.

Furthermore, measured results also include measurement errors, which may cause different measured results of adjacent thermopiles which should be the same results originally. Such measurement errors can be reduced by executing averaging processing in adjacent thermopiles into an allowable range.

When the averaging processing is executed in adjacent thermopiles, however, if output signals include noises, the measured results are adversely affected. Thus, although averaging processing can reduce measurement errors, the measured results will be adversely affected.

Accordingly, it is necessary to remove noises as much as possible before the execution of the averaging processing. If noises can be removed, measurement errors can be reduced effectively by the averaging processing, resulting in improved measurement accuracy.

As will be apparent from the above, the order of processing is important. Concretely, a noise removing processing should be executed initially, and then an averaging processing should be executed.

Noises can be removed by various known methods. Examples of known methods include analog processing using an LPF (low-pass filter) including a resistance and a capacitor and digital processing by software using a microcomputer. In this embodiment, the analog processing is performed by the LPF 8 constituted by a resistance and a capacitor and the digital processing is performed by the CPU 12 based on the program stored in the PROM 13 using the digital data converted by the A/D converter 10 shown in FIG. 1 to remove noises. As a method of removing noises by digital processing, a “3DDNR” (three dimensional digital noise reduction) method and a median filtering method can be exemplified.

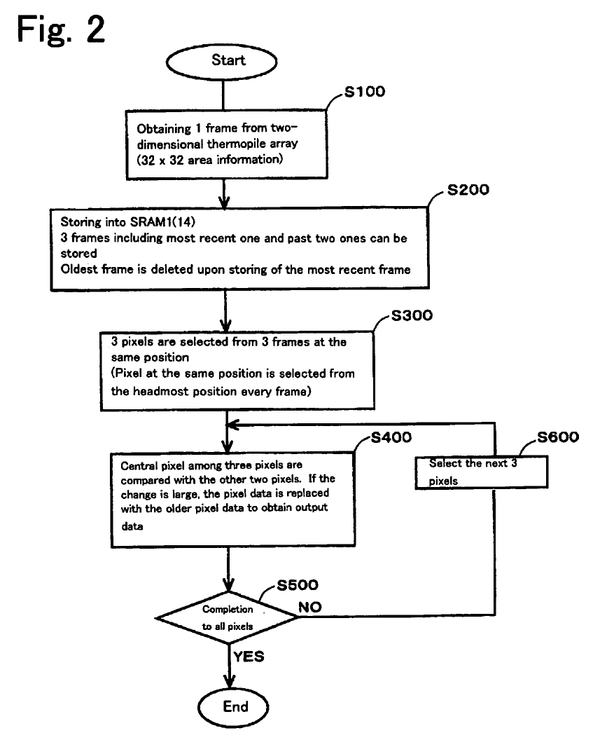

A concrete example of the aforementioned 3DDNR (three dimensional digital noise reduction) method will be explained with reference to the flowchart shown in FIG. 2.

The CPU 12 makes the SRAM1 14 store the data of one frame (32×32) from the two-dimensional thermopile array 2 (Step S100). The SRAM1 14 can store past three data (three frames). The SRAM1 14 stores the updated frame and deletes the oldest frame (Step S200). The CPU 12 obtains three pixel data of the same position from the past three data (three frames) stored in the SRAM1 14 into the register in the CPU 12 (Step S300). The CPU 12 compares the pixel data immediately older than the updated pixel data with the other two pixel data, i.e., the updated pixel data and the oldest pixel data. If the difference is large, the CPU 12 outputs the oldest pixel data in place of the pixel data immediately older than the updated pixel data to the SRAM2 15 (Step S400).

Then, it is discriminated whether the processing to all of the pixels has been completed (Step S500). If the processing has not been completed yet (NO at Step S500), the next three pixels will be selected (Step S600). To the contrary, if the processing has been completed (YES at Step S500), the processing terminates.

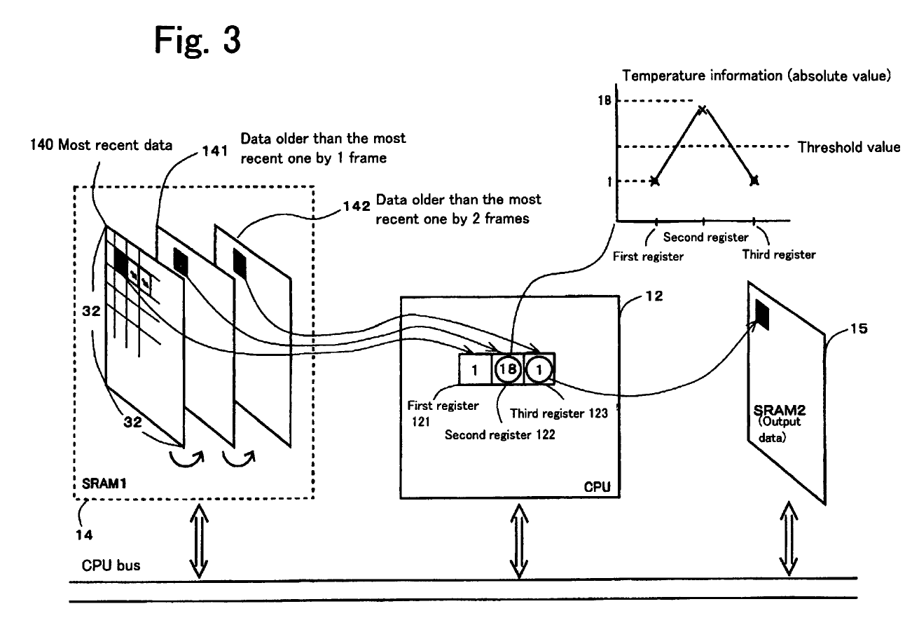

Operations at Step S300 and Step S400 will be explained concretely with reference to FIG. 3. As shown in FIG. 3, SRAM1 14 can store the past three data (three frames). The temperature information of the detecting area 5 is obtained three times per second. In other words, the updated temperature information is overwritten on the oldest temperature information every 300 ms.

From the past three data (three frames), three pixel data of the same location are stored in the first register 121, the second register 122 and the third register 123 in the CPU 12. The most recent data is stored in the first register 121, the next recent data older than the most recent data is stored in the second register 122, and the oldest data is stored in the third register 123.

The embodiment shown in FIG. 3 shows the state in which the first register 121 stores “1” as temperature information, the second register 122 stores “18” as temperature information and the third register 123 stores “1” as temperature information. In this embodiment, the temperature information of “18” stored in the second register 122 is extremely larger than that of “1” stored in the first register 121 and that of “1” stored in the third register 123. In the case of a heat detector for measuring temperature changes, the fact that a large numerical value is appeared in a short period of time or a large numeral is disappeared in a short period of time is commonly considered to be caused by noises.

In order to remove the noises, a certain threshold value is set to the point apart from the values stored in the first register 121 and the third register 123 as shown in FIG. 3 by a predetermined value. If the value stored in the second register 122 exceeds the threshold value, the value stored in the third register 123 which is the data before the value stored in the second register 122 is outputted in place of the value stored in the second register 122.

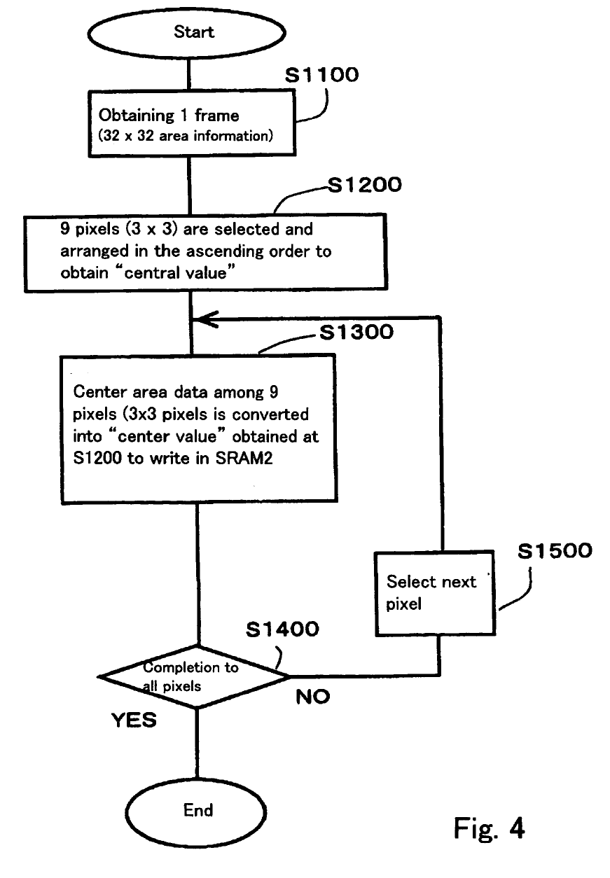

Next, the aforementioned median filtering method as a noise removing method will be explained with reference to the flowchart shown in FIG. 4. The CPU 12 imports area information of one frame from the SRAM1 14 via the CPU bus (Step S1100). The reason that the processing is executed every one frame is as follows. That is, if area information is processed every divided section, the CPU 12 should frequently access the SRAM1 14, resulting in a heavy burden to the CPU bus.

The headmost 3×3 nine pixels in one frame are selected, and the pixels are arranged in descending order, thereafter the central value is calculated (Step S1200). The central area information in the 3×3 nine pixels is converted to the central value obtained at Step S1200, and the converted data is written in SRAM2 15 (Step S1300). Then, it is discriminated whether the processing to all of the pixels has been completed (Step S1400). If the processing has not been completed yet (NO at Step S1400), the next 3×3 nine pixels will be selected (Step S1500). To the contrary, if the processing has been completed (YES at Step S1400), the processing terminates.

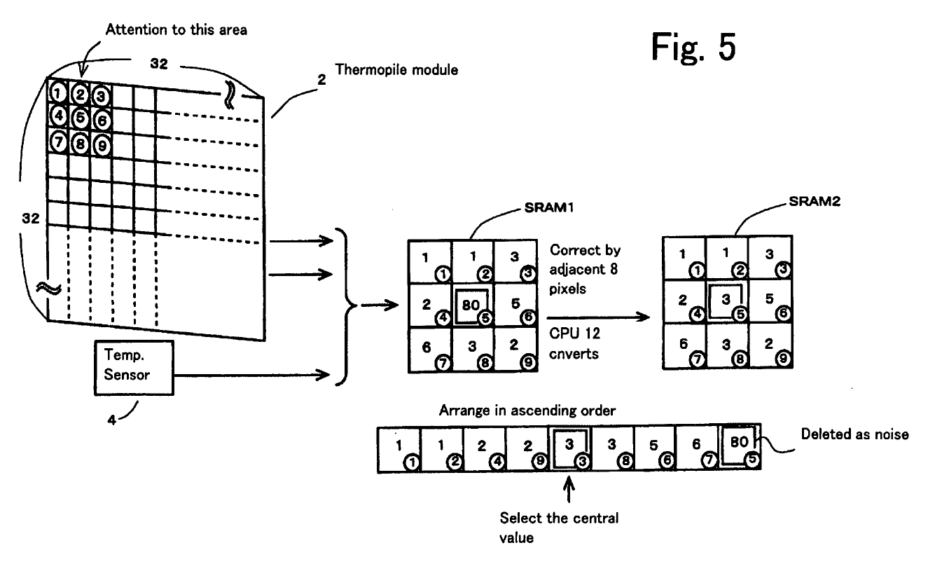

Operations at Step S1200 and Step S1300 will be explained concretely with reference to FIG. 5. As shown in FIG. 5, the headmost 3×3 nine pixels are selected from the 32×32 area information (one frame). In this case, the 3×3 nine pixels are located at a first area, a second area and a third area from the left end of the first row, a fourth area, a fifth area and a sixth area from the left end of the second row, and a seventh area, an eighth area and a ninth area from the left end of the third row.

According, in this case, the central position is located at the fifth area. The area information of the fifth area will be corrected based on the information from the first area to the fourth area and from the sixth area to the ninth area. In the example shown in FIG. 3, each area information is voltage data showing the temperature of each area. It is understood that the area information of the fifth area is 80 which is extremely higher than the area information of the other area.

In the case of a heat detector for measuring temperature changes, it is hardly understood that the area information of the fifth area is extremely higher than that of the other area surrounding the fifth area. Accordingly, if voltage data showing temperature of areas includes an extremely high voltage data, it is appropriate to consider that noises are included.

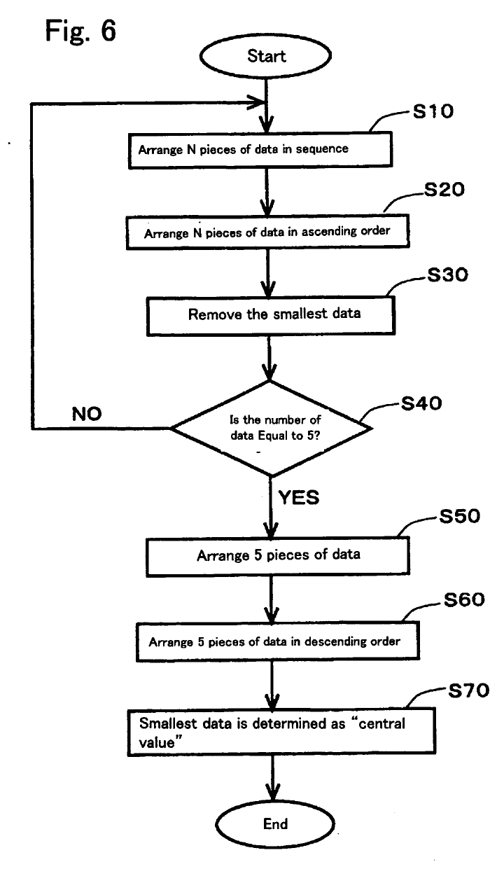

FIG. 6 shows a flowchart showing a concrete example of a method for obtaining a median value among nine numeric values. In order to obtain a median value among nine numeric values, initially, the smallest value is obtained among the nine values and removed therefrom. Then, the smallest value is obtained among the eight values and removed therefrom. Thus, the smallest value among five values can be obtained by repeating the aforementioned operation. The smallest value among the nine value is the median value.

Next, in the case of obtaining a median value among n pieces of numeric values wherein “n” denotes an integer value and starts 9, the operation will be performed as follows. N pieces of data are arranged in ascending order (Step S20). Then, the smallest data is removed from the n pieces of data (Step S30). The number of data is compared with 5 (Step S40). If the number of data is larger than 5 (NO at Step S40), the routine proceeds to Step S10. To the contrary, if the number of data is equal to 5 (YES at Step S40), the five pieces of data are set in array (Step S50). Then, the five pieces of data are arranged in descending order (Step S60). The smallest data is picked up as the median value (Step S70), and the processing terminates.

In the processing shown in FIG. 5, in accordance with the flowchart shown in FIG. 6, the median value is obtained from the area information from the first area to the ninth area. Then, the information of the fifth area is replaced with the median value. Thus, noise that caused the value 80 in the fifth area can be removed.

By combining the 3DDNR (three dimensional digital noise reduction) method and a median filtering method, noise can be removed more effectively. As for the order of these method, it should be noted that more effective noise removal can be attained by initially performing the 3DDNR and then performing the median filtering method. The reason that it is more effective to initially perform the 3DDNR is as follows. That is, it considered to be unnatural that extremely large value is inputted in a short period of time, and therefore it is easily recognized as noise.

After the removal of noise, averaging processing for reducing measurement errors is executed. Examples of averaging processing include, e.g., a method of moving averages and a method of inter-frame averages.

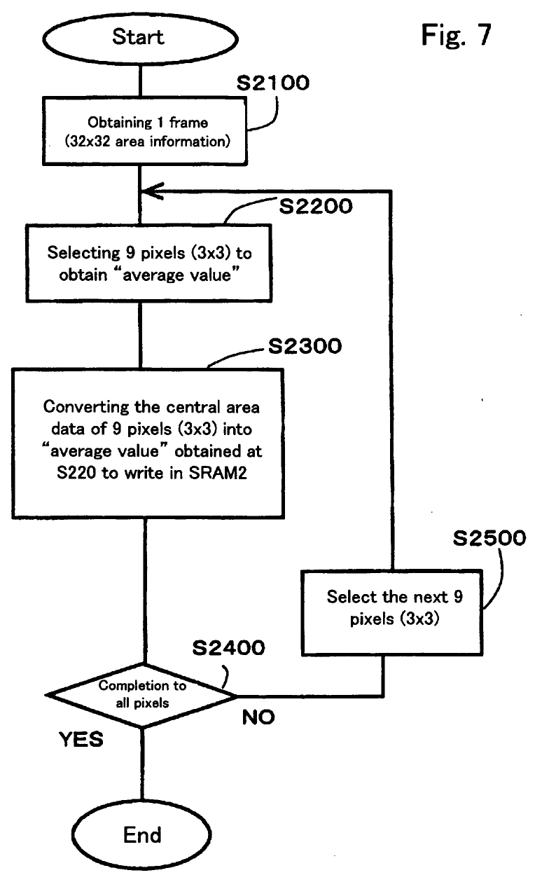

A method of moving averages will be explained with reference to the flowchart shown in FIG. 7.

The CPU 12 obtains the area information of one frame from the SRAM1 14 via the CPU bus (Step S2100). The reason that the processing is executed every one frame is that, if area information is processed every divided section, the CPU 12 should frequently access the SRAM1 14, resulting in a heavy burden to the CPU bus.

The CPU 12 selects the headmost 3×3 nine pixels in one frame and calculates the average value of the nine pixels (Step S2200). Then, the central area information in the 3×3 nine pixels is converted into the average value obtained at Step S200 and overwritten in the SRAM2 15 (Step S2300). It is discriminated whether the processing is executed to all of the pixels (Step S2400). If the processing has not been completed yet (NO at Step S2400), the next 3×3 nine pixels will be selected (Step S2500). To the contrary, if the processing has been completed (YES at Step S2400), the processing terminates.

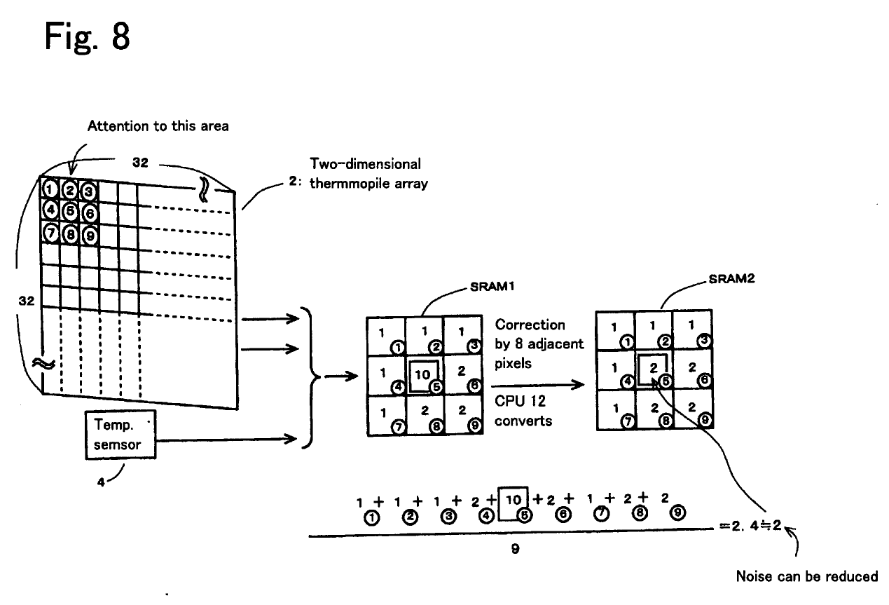

Operations at Step S2200 and Step S2300 will be explained concretely with reference to FIG. 8. As shown in FIG. 8, the headmost 3×3 nine pixels are selected from the 32×32 area information (one frame). In this case, the 3×3 nine pixels are located at a first area, a second area and a third area from the left end of the first row, a fourth area, a fifth area and a sixth area from the left end of the second row, and a seventh area, an eighth area and a ninth area from the left end of the third row.

According, in this case, the central position is located at the fifth area. The area information of the fifth area will be corrected based on the information from the first area to the fourth area and from the sixth area to the ninth area. In the example shown in FIG. 8, each area information is voltage data showing the temperature of each area. It is understood that the area information of the fifth area is 10 which is extremely higher than the area information of the other area.

In the case of a heat detector for measuring temperature changes, it is hardly understood that the area information of the fifth area is extremely higher than that of the other area surrounding the fifth area. Accordingly, if voltage data showing temperature of areas includes an extremely high voltage data, it is appropriate to consider that noise is included.

In the processing shown in FIG. 8, an average value is obtained from the area information from the first area to the ninth area. In this case, the first area, the second area and the third area are located from the left end of the first row, the fourth area, the fifth area and the sixth area are located from the left end of the second row, and the seventh area, the eighth area and the ninth area are located from the left end of the third row.

From the 32×32 area information (one frame), the headmost 3×3 nine pixels are selected. The central area is the fifth area. The average value of the fifth area can be obtained by adding the area information from the first area to the ninth area and dividing the added value with 9.

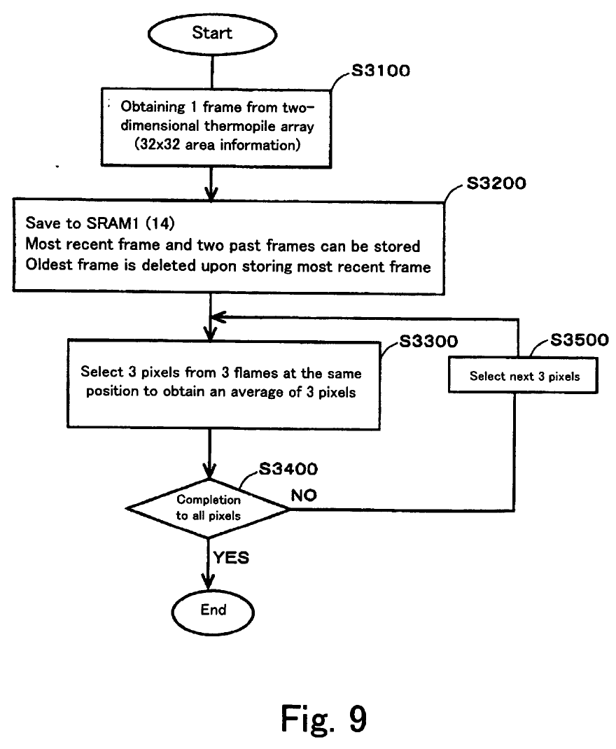

Next, the aforementioned inter-frame averaging processing will be explained with reference to the flowchart shown in FIG. 9.

The CPU 12 makes the SRAM1 14 store the data of one frame (32×32) from the two-dimensional thermopile array 2 (Step S3100). The SRAM1 14 can store past three data (three frames). The SRAM1 14 stores the updated frame and deletes the oldest frame (Step S3200). The CPU 12 obtains three pixel data of the same position from the past three data (three frames) stored in the SRAM1 14 into the register in the CPU 12 (Step S3300). Then, it is discriminated whether the processing to all of the pixels has been completed (Step S3400). If the processing has not been completed yet (NO at Step S3400), the next three pixels will be selected (Step S3500). To the contrary, if the processing has been completed (YES at Step S3400), the processing terminates.

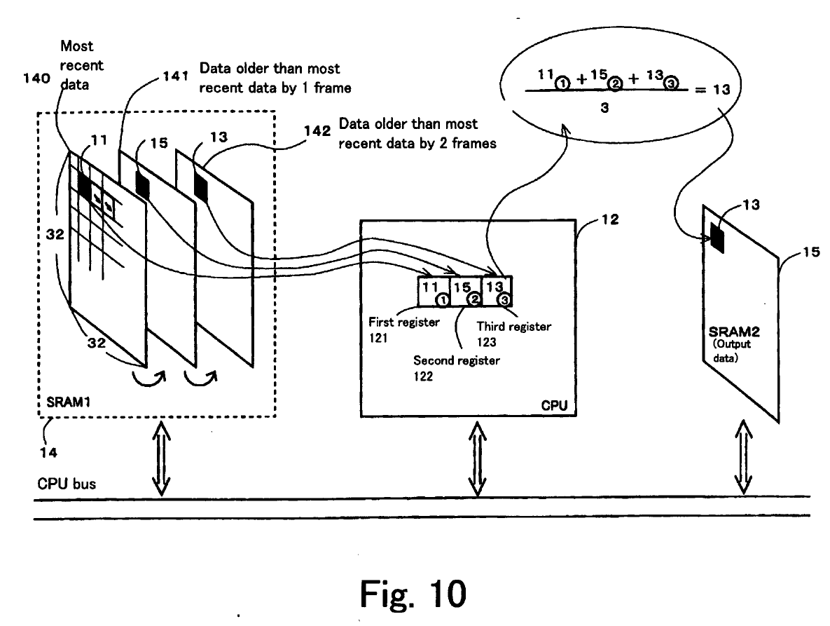

The operation at Step S3300 will be explained concretely with reference to FIG. 10. As shown in FIG. 10, the SRAM1 14 can store the data of the past three data (three frames). The SRM1 14 can write the temperature information of the detecting area 5 therein via the CPU bus. The temperature information of the detecting area 5 is obtained three times per second. In other words, the updated temperature information is overwritten on the oldest temperature information every 300 ms.

From the past three data (three frames), three pixel data of the same location are stored in the first register 121, the second register 122 and the third register 123 in the CPU 12. The most recent data is stored in the first register 121, the next recent data older than the most recent data is stored in the second register 122, and the oldest data is stored in the third register 123.

The embodiment shown in FIG. 10 shows the state in which the first register 121 stores “11” as temperature information, the second register 122 stores “15” as temperature information and the third register 123 stores “13” as temperature information. The CPU 12 obtains the average value from values stored in the first register 121, the second register 122 and the third register 123, and outputs the average data in place of the value of the second register 122. The outputted average data in place of the value stored in the second register 122 is outputted to the SRAM2 15.

By combining the method of moving averages and the method of inter-frame averages, measurement errors can be removed more effectively. As for the order of these methods, it should be noted that more effective noise removal can be attained by initially performing the method of moving averages and then performing the method of inter-frame averages. The reason that it is more effective to perform the method of inter-frame averages later is as follows. That is, it considered to be unnatural that extremely large value is inputted in a short period of time. Therefore, at the final stage of displaying image data on a screen of the personal computer 18, it becomes possible to reduce measurement errors by performing the method of inter-frame averages which is time averaging processing at the same measuring unit to create the image data.

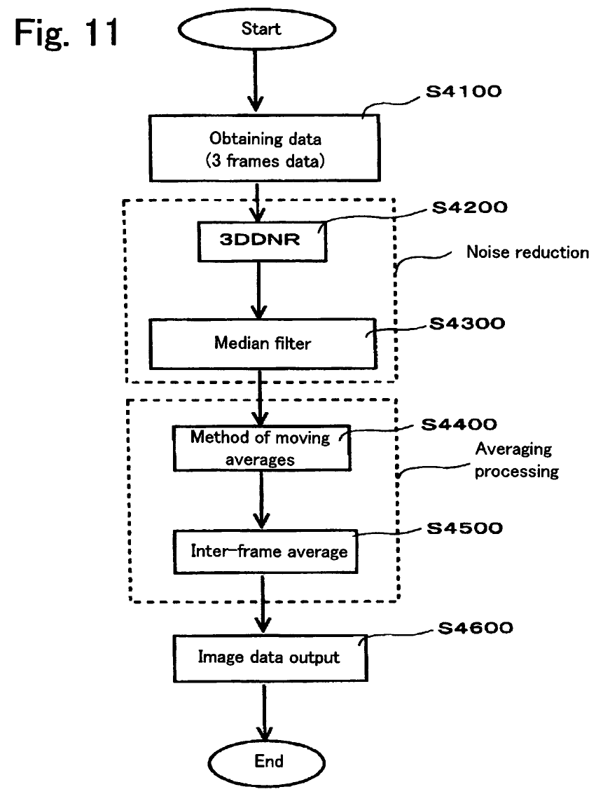

FIG. 11 is a flowchart showing a series of noise removing and averaging processing. The CPU 12 obtains the data of three frames (32×32) at Step S4100. As a first step for removing noise, the 3DDNR (three dimensional digital noise reduction) method shown in FIGS. 2 and 3 is performed (Step S4200). As a second step for removing noise, the median filtering method shown in FIGS. 4, 5 and 6 is performed (Step S4300). As a first step of the averaging processing, the method of moving averages shown in FIGS. 7 and 8 (Step S4400). Then, as a second step of the averaging processing, the method of inter-frame averages shown in FIGS. 9 and 10 is performed (Step S4500). The CPU 12 outputs the data to which the noise removing processing and the averaging processing were executed as image data. In the processing shown in FIG. 11, although the noise removing processing and the averaging processing are performed separately, three-dimensional processing and second-dimensional processing can be performed separately.

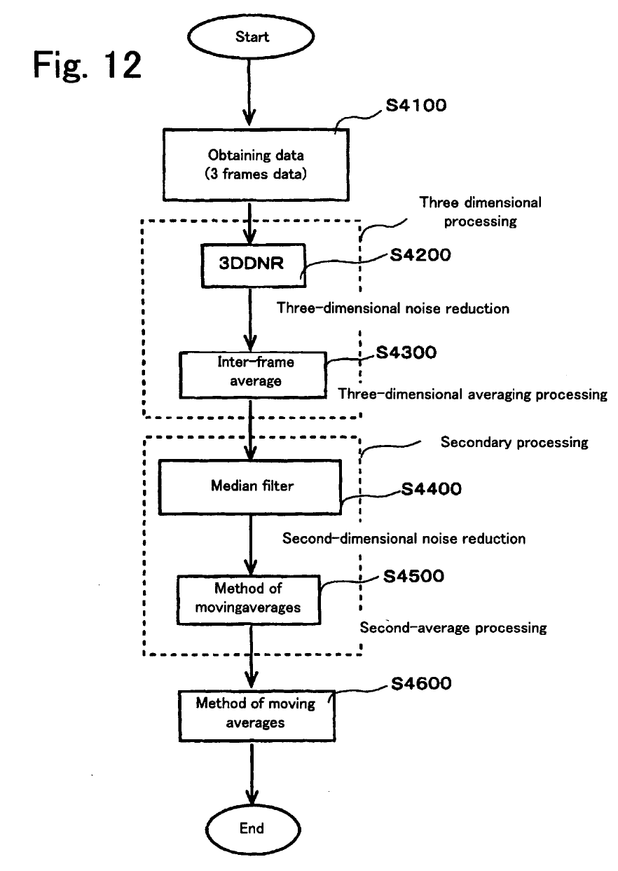

FIG. 12 is a flowchart showing processing in which three-dimensional processing is performed as the first stage and second-dimensional processing is performed as the second stage.

In the case of performing the third-dimensional processing too, the 3DDNR (three dimensional digital noise reduction) method for performing three-dimensional noise reduction (Step S4200) and the inter-frame averaging method for performing three dimensional averaging processing (Step S4500) are performed. Subsequently, median filtering processing for two-dimensional noise reduction is performed (Step S4300) and a method of moving averages for two-dimensional averaging processing is performed. The same results can be obtained by performing the three-dimensional processing and the two-dimensional processing.

While the present invention may be embodied in many different forms, a number of illustrative embodiments are described herein with the understanding that the present disclosure is to be considered as providing examples of the principles of the invention and such examples are not intended to limit the invention to preferred embodiments described herein and/or illustrated herein.

While illustrative embodiments of the invention have been described herein, the present invention is not limited to the various preferred embodiments described herein, but includes any and all embodiments having equivalent elements, modifications, omissions, combinations (e.g., of aspects across various embodiments), adaptations and/or alterations as would be appreciated by those in the art based on the present disclosure. The limitations in the claims are to be interpreted broadly based on the language employed in the claims and not limited to examples described in the present specification or during the prosecution of the application, which examples are to be construed as non-exclusive. For example, in the present disclosure, the term “preferably” is non-exclusive and means “preferably, but not limited to.” In this disclosure and during the prosecution of this application, means-plus-function or step-plus-function limitations will only be employed where for a specific claim limitation all of the following conditions are present in that limitation: a) “means for” or “step for” is expressly recited; b) a corresponding function is expressly recited; and c) structure, material or acts that support that structure are not recited. In this disclosure and during the prosecution of this application, the terminology “present invention” or “invention” is meant as a non-specific, general reference and may be used as a reference to one or more aspect within the present disclosure. The language present invention or invention should not be improperly interpreted as an identification of criticality, should not be improperly interpreted as applying across all aspects or embodiments (i.e., it should be understood that the present invention has a number of aspects and embodiments), and should not be improperly interpreted as limiting the scope of the application or claims. In this disclosure and during the prosecution of this application, the terminology “embodiment” can be used to describe any aspect, feature, process or step, any combination thereof, and/or any portion thereof, etc. In some examples, various embodiments may include overlapping features. In this disclosure and during the prosecution of this case, the following abbreviated terminology may be employed: “e.g.” which means “for example;” and “NB” which means “note well.”

What is claimed is:

1. A noise reduction circuit for use in a temperature measuring apparatus, the noise reduction circuit, comprising:
a replacing processing portion configured to execute replacing processing for replacing data of one of plural pixels among plural pixels with data of another pixel among the plural pixels, the data of the one of plural pixels being discriminated as noise; and
an averaging processing portion configured to execute averaging processing for averaging the data of the one of plural pixels to smooth the data of the one of plural pixels,
wherein the averaging processing is executed at the averaging processing portion after executing the replacing processing at the replacing processing portion.

2. The noise reduction circuit as recited in claim 1, wherein the replacing processing portion executes the replacing processing by comparing signals generated at the one of plural pixels at different times, and wherein the averaging processing portion executes the averaging processing by averaging signals generated from the one of plural pixels at different times.

3. The noise reduction circuit as recited in claim 1, wherein the replacing processing portion executes the replacing processing by comparing signals generated at the one of plural pixels at different times and replacing the data of the one of plural pixels with data of a pixel before or after the data of the one of plural pixels, and wherein the averaging processing portion averages the data of the one of plural pixels by averaging the data of the one of plural pixels and the data of pixels located around the one of plural pixels to smoothen the data of the one of plural pixels.

4. The noise reduction circuit as recited in claim 1, wherein the replacing processing portion replaces data of a central pixel discriminated as noise among data of the plural pixels with any one of data of pixels around the central pixel by comparing data of the central pixel with data of the pixels around the central pixel, and wherein the averaging processing portion smoothes the data of the central pixel by averaging the data of the central pixel and data of the pixels around the central pixel.

5. The noise reduction circuit as recited in claim 1, wherein the replacing processing portion replaces data of a central pixel discriminated as noise among data of the plural pixels with data of one of pixels around the central pixel by comparing the data of the central pixel with the data of the one of pixels around the central pixel, and wherein the averaging processing portion smoothens the data of the central pixel by averaging the signals generated at the central pixel at different times.

6. The noise reduction circuit as recited in claim 1, wherein the replacing processing portion compares data of a central image among three images consecutive in time with data of two remaining images and replaces the data of the central image with one of data of the two remaining images depending on a result of the comparison.

7. The noise reduction circuit as recited in claim 1, wherein the replacing processing portion compares one pixel data with pixel data adjacent in two-dimension, and replaces the one pixel data with any one of the adjacent pixel data.

8. The noise reduction circuit as recited in claim 1, wherein the replacing processing portion obtains an average value of one pixel data and pixel data adjacent to the one pixel data in two-dimension, and replaces the one pixel data with the average pixel data.

9. The noise reduction circuit as recited in claim 1, wherein the averaging processing portion obtains an average value of data of a central screen among three screens consecutive in time and data of two remaining screens, and replaces the data of the central screen with the average value.

10. The noise reduction circuit as recited in claim 1, wherein the replacing processing portion compares data of a central image of three screens consecutive in time with data of images of two remaining screens, replaces the data of the central image with data of any one of images of the two remaining screens depending on a result of the comparison, compares one pixel data with pixel data adjacent to the one pixel data in two-dimension, and wherein the averaging processing portion performs the averaging processing after replacing the one pixel data with any one of adjacent pixel data.

11. The noise reduction circuit as recited in claim 1, wherein the averaging processing portion obtains an average value of data of one pixel and data of pixels adjacent to the one pixel in two-dimension, replacing the data of the one pixel with the average value, obtains an average value of data of a central screen of three screens consecutive in time and data of two remaining data, and replaces the data of the central image with the average value.

12. The noise reduction circuit as recited in claim 1, wherein the replacing processing portion compares data of a central image of three screens consecutive in time with data of images of two remaining screens, replaces the data of the central image with data of any one of images of the two remaining screens depending on a result of the comparison, compares one pixel data with pixel data adjacent to the one pixel data in two-dimension, and replaces the one pixel data with any one of pixel data adjacent to the one pixel data in two-dimension, thereafter, the averaging processing portion obtains an average value of data of one pixel and data of pixels adjacent to the one pixel in two-dimension, replacing the data of the one pixel with the average value, obtains an average value of data of a central screen of three screens consecutive in time and data of two remaining data, and replaces the data of the central image with the average value.

13. A temperature measuring apparatus with a temperature correction function, comprising:
a light receiving portion having a plurality of light receiving units for measuring heat quantity of divided temperature detecting area, the light receiving portion measuring a relative temperature difference between each of the light receiving units and its corresponding divided temperature detecting area in a non-contact manner;
a thermal sensor for detecting a temperature of each of the plurality of light receiving units; and
a replacing processing portion configured to calculate a temperature of each divided temperature detecting area by calculating the temperature from the thermal sensor and the relative temperature difference obtained by the light receiving portion to obtain a temperature of each detecting area, and replace a value discriminated as noise by comparing the calculated result; and
a calculating circuit having an averaging processing portion for smoothening changes by averaging the calculated results,
wherein the calculating circuit executes averaging processing by the averaging processing portion after executing the replacing processing by the replacing processing portion.

14. The temperature measuring apparatus as recited in claim 13, wherein the temperature measuring apparatus is applied to a heat detector in which measured values of the detecting area obtained in non-contact manner are amplified.

15. A temperature measuring apparatus, wherein the temperature measuring apparatus comprises a noise reduction circuit as recited in claim 1.
